(19) United States
(12) Patent Application Publication
(10) Pub. No.: US 2025/0119387 A1
(43) Pub. Date: Apr. 10, 2025

(54) METHOD AND APPARATUS FOR PROCESSING DATA IN TIME-SENSITIVE NETWORK, DEVICE AND MEDIUM

(71) Applicant: Continental Automotive Technologies GmbH, Hannover (DE)

(72) Inventors: Xianhui Yang, Chongqing (CN); Xianfang Luo, Chongqing (CN); Xuexue Lei, Shanghai (CN)

(73) Assignee: Continental Automotive Technologies GmbH, Hannover (DE)

(21) Appl. No.: 18/894,834

(22) Filed: Sep. 24, 2024

(30) Foreign Application Priority Data
Oct. 7, 2023 (CN) 202311295206.7

(51) Int. Cl. H04L 47/28; H04L 43/0852

(52) U.S. Cl. CPC H04L 47/28; H04L 43/0852

(57) ABSTRACT

A method for processing time-sensitive data in a time-sensitive network includes acquiring a first time, a second time and a third time. The first time is a time when the data is actually scheduled, the second time is a time when a gate control operation of the data is planned to begin, and the third time is a duration of a gate control operation of the data. The method also includes identifying whether the data enters a sending queue abnormally based on the first time, the second time and the third time acquired. If the data enters a sending queue abnormally, inform a sender of the data to adjust a sending time.

### CROSS-REFERENCE TO RELATED APPLICATION

This application claims the benefit of Chinese patent application No. 202311295206.7 filed on Oct. 7, 2023, which is hereby incorporated by reference.

### TECHNICAL FIELD

The technical field relates generally to network communication, in particular to a method and apparatus for processing data in a TSN (time-sensitive network), a device and a medium.

### BACKGROUND

In the field of motor vehicles, applications such as advanced driver assistance, on-board audio synchronization and the Internet of Vehicles have high requirements in terms of latency; it is necessary to ensure low latency and deterministic latency in data transmission. A TSN (time-sensitive network) can effectively satisfy the latency requirements for time-sensitive data in on-board networks, ensuring the low-latency requirement for time-sensitive data to a certain extent. However, currently, TSN gate control lists are deployed in a switch after offline static computation, ignoring non-deterministic latency caused by network card processing of the sending end in the network, link transmission and switch grouping, etc.; aging of transmission equipment may even cause a change in latency in data packet transmission. Thus, existing networks cannot guarantee deterministic latency in the transmission of time-sensitive data.

### SUMMARY

In view of the above, embodiments described herein provide a method and apparatus for processing data in a time-sensitive network, a device, and a medium, which enable data to have deterministic latency.

A method for processing data in a time-sensitive network according to embodiments is presented, wherein the data is time-sensitive data. The method includes acquiring a first time, a second time and a third time. The method also includes identifying whether the data enters a sending queue abnormally on the basis of the first time, the second time and the third time acquired. If the data enters a sending queue abnormally, telling a sender of the data to adjust a sending time. The first time is a time when the data is actually scheduled, the second time is a time when a gate control operation of the data is planned to begin, and the third time is a duration of a gate control operation of the data.

When the difference between the first time and the second time is greater than the third time, or when the difference between the first time and the second time is less than 0, the data enters a sending queue abnormally.

The sender of the data is told to adjust the sending time on the basis of a delay value of the data, wherein the delay value is computed on the basis of the first time and a fourth time, the fourth time being a time when the data is planned to be scheduled.

A delay value of data is computed multiple times, and a smoothing algorithm is used to subject multiple computed delay values to smoothing, so as to obtain a final delay value, and the sender is told to adjust the sending time on the basis of the final delay value.

The method further includes identifying whether the data is time-sensitive data, and upon identifying that the data is time-sensitive data, putting the data into a sending queue having the highest priority.

The method further includes identifying whether an abnormal flow processing function is activated, and when it is activated, performing the step of identifying whether the data enters a sending queue abnormally.

A value of a function register is used to indicate activation or deactivation of the abnormal flow processing function.

A method for processing data in a time-sensitive network according to embodiments includes the following steps: receiving at least one item of data; allocating the at least one item of data to multiple sending queues on the basis of a characteristic of the at least one item of data, wherein time-sensitive data is allocated to a sending queue having the highest priority; scheduling data in the multiple sending queues on the basis of a preset gate control list; when scheduling the time-sensitive data, monitoring whether the time-sensitive data enters the sending queue having the highest priority normally; and upon detecting that the time-sensitive data enters the sending queue having the highest priority abnormally, performing an adjustment operation, so that the time-sensitive data is able to enter the sending queue having the highest priority normally.

When the time-sensitive data enters a sending queue early or late and is not scheduled within a specified gate control time, the time-sensitive data is considered to enter a sending queue abnormally.

An apparatus for processing data in a time-sensitive network is also presented, the data being time-sensitive data. The apparatus includes an acquisition module, for acquiring a first time, a second time and a third time. The apparatus also includes an identification module, for identifying whether the data enters a sending queue abnormally on the basis of the first time, the second time and the third time acquired by the acquisition module. The apparatus further includes a notification module, for telling a sender of the data to adjust a sending time when the identification module identifies that the data enters a sending queue abnormally, wherein the first time is a time when the data is actually scheduled, the second time is a time when a gate control operation of the data is planned to begin, and the third time is a duration of a gate control operation of the data.

A switch according to embodiments includes a receiving port, for receiving data and allocating the data to multiple sending queues, wherein, when the data is time-sensitive data, the data is allocated to a sending queue having the highest priority; a gate control assembly, comprising multiple gate control elements, respectively corresponding to the multiple sending queues; and a processing module, for controlling the on/off switching of each gate control element in the gate control assembly on the basis of a gate control list, and thereby scheduling data in the multiple queues, wherein the processing module is further used for: for the sending queue having the highest priority, monitoring whether data therein enters the sending queue abnormally; and upon detecting that data enters the sending queue abnormally, telling a sender to adjust a sending time.

The action of monitoring whether data enters a sending queue abnormally is performed on the basis of a first time, a second time and a third time, wherein the first time is a time when the data is actually scheduled, the second time is a time when a gate control operation of the data is planned to begin, and the third time is a duration of a gate control operation of the data.

An electronic device according to embodiments includes a processor; and a memory, for storing an executable instruction of the processor, wherein the processor is configured to execute the executable instruction to implement the processing method according to embodiments of the present invention.

A computer-readable storage medium according to embodiments has a computer program stored thereon, the computer program comprising an executable instruction, wherein, when the executable instruction is executed by a processor, the processing method according to embodiments described herein is implemented.

In embodiments described herein, by identifying whether a time-sensitive data stream enters a sending queue abnormally, and telling a sender to adjust a sending time when a sending queue is entered abnormally, the time-sensitive data stream is enabled to enter a sending queue normally, i.e., enabled to have deterministic latency.

### BRIEF DESCRIPTION OF THE DRAWINGS

Other details and advantages of the disclosure will become obvious through the detailed description provided below. It should be understood that the drawings listed below are merely schematic and therefore should not be regarded as limiting the present invention, and a detailed description is given below with reference to the drawings, wherein:

FIG. 1 is a time sequence diagram for data in a TSN.

FIG. 2 is a schematic flow chart of an embodiment of the method for processing data.

FIG. 3 is a schematic flow chart of another embodiment of the method for processing data.

FIG. 4 is a structural schematic drawing of an embodiment of the apparatus for processing data.

FIG. 5 is a structural schematic drawing of an embodiment of the switch.

FIG. 6 is a structural schematic drawing of an embodiment of the electronic device.

### DETAILED DESCRIPTION

The disclosed subject matter is explained in further detail below with reference to the drawings and embodiments. It should be understood that the particular embodiments described here merely explain the disclosed subject matter and are not intended to limit it.

In this description, it should be understood that the terms “first” and “second” are merely used for descriptive purposes, and must not be interpreted as indicating or implying relative importance or implicitly specifying the quantity of the technical feature indicated. Thus, a feature for which “first” and “second” are defined may explicitly or implicitly include one or more of the feature. Moreover, the terms “first” and “second”, etc. are suitable for distinguishing between similar objects, and need not be used to describe a specific order or sequence. It should be understood that terms used in this way may be interchanged in suitable circumstances, to enable an embodiment of the disclosure described herein to be implemented in a different order from those shown or described herein.

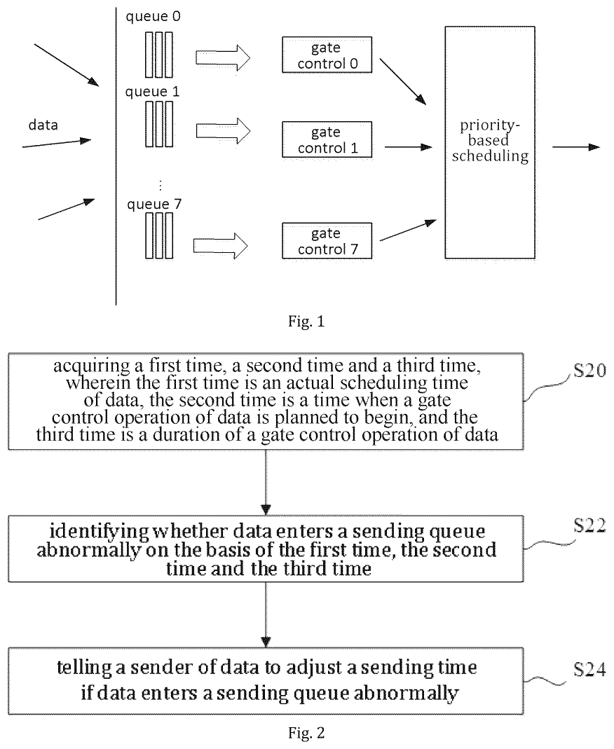

FIG. 1 shows a time sequence diagram for data processing in a TSN (time-sensitive network). As shown in the figure, once data has entered, the data is allocated to different sending queues (abbreviated as “queues”), based on whether the data is time-sensitive. Characteristics such as source MAC address, destination MAC address and VLAN ID (Virtual Local Area Network Identity Document) in the data are used to identify whether the data is time-sensitive. There may be 8 queues, which may be respectively labelled as queue 0 to queue 7, and the priorities of queue 0 to queue 7 increase sequentially, i.e. queue 7 has the highest priority. When data is identified as being time-sensitive, it is allocated to queue 7. As shown in the figure, queues 0 to 7 respectively correspond to gate control 0 to gate control 7, and gate controls 0 to 7 are controlled to control the onward transmission of data in queues 0 to 7. The gate controls are similar to switches, being opened or closed to control whether data in the corresponding queues can be transmitted onward. The switching logic of gate control 0 to gate control 7, and the duration of opening or closing, are controlled by a gate control list, which may be statically configured in advance. For example, one example of a gate control list is shown in Table 1 below.

TABLE 1

| Gate operation number | Gate state | Gate state duration |
|---|---|---|
| 1 | 11001010 | 50 |
| 2 | XXXXXXXX | XXX |
| 3 | XXXXXXXX | XXX |
| 4 | XXXXXXXX | XXX |
| 5 | XXXXXXXX | XXX |
| 6 | XXXXXXXX | XXX |
| . . . | . . . | . . . |
| 16 | 00101010 | 100 |

In Table 1, the content of the gate control list comprises: gate operation number, gate state and gate state duration. During execution, gate operations corresponding to the gate operation numbers are executed periodically in order of increasing gate operation number, e.g. each gate control is controlled on the basis of gate state and duration. Each bit in the gate state corresponds to the state of one gate control, e.g. in the gate state “11001010”, “0” signifies that the gate control is closed, and “1” signifies that “the gate control is open” so this gate state means that gate controls 0, 2, 4 and 5 are closed, and gate controls 1, 3, 6 and 7 are open. The gate state duration signifies how long the current gate state will last; when the gate state times out, a switch will take place to the next gate operation number, to execute the corresponding gate operation.

As shown in FIG. 1, there are cases where multiple gate controls are opened simultaneously among gate control 0 to gate control 7, i.e. there are cases where data from different queues are transmitted onward simultaneously; at this time, these data will be scheduled according to the priorities of queues 0 to 7, i.e. data with higher priority will be scheduled first. Thus, since time-sensitive data is always allocated to the queue having the highest priority, time-sensitive data can always be scheduled with the highest priority, so that the time-sensitive data can have a low latency characteristic.

In the above solution, when time-sensitive data does not enter a sending queue according to an agreed time, this may result in delay jitter in the time-sensitive data, encroaching on a transmission window for non-time-sensitive data. In a communication network (such as an on-board network), if such a situation is not dealt with promptly and allowed to accumulate in the entire transmission link, it might have a serious impact on a service.

Thus, embodiments described herein provide a solution for processing data in a time-sensitive network, to monitor whether time-sensitive data enters a queue normally, and instruct adjustment of a moment of sending by a sender upon detecting that time-sensitive data enters a queue abnormally, to enable the time-sensitive data to enter a queue normally. This ensures that time-sensitive data has deterministic latency while also ensuring that time-sensitive data has low latency.

FIG. 2 shows a schematic flow chart of an embodiment of the method for processing data in a time-sensitive network. The method includes step S20, acquiring a first time, a second time and a third time.

The first time is the time when data is actually scheduled, and may be obtained by monitoring. The second time is the time when a gate control operation of data is planned to begin. The third time is the duration of the gate control operation of data, and may be obtained on the basis of a gate control list.

Here, the data is time-sensitive data; a characteristic of the data itself, such as a source MAC address or destination MAC address of the data, may be used to identify whether the data is time-sensitive data. Furthermore, referring to the description of FIG. 1, time-sensitive data is allocated to the queue having the highest priority. In other words, the data referred to in this embodiment may also mean data in the queue having the highest priority; in this embodiment, data in the queue having the highest priority may be monitored directly, in order to acquire the first time, the second time and the third time.

Step S22, identifying whether data enters a sending queue abnormally on the basis of the first time, the second time and the third time acquired in step S20.

Scenarios in which data enters a sending queue abnormally may include: data arrives late, and is not scheduled within a planned gate control time (e.g. a planned gate control window), or data arrives early, and is not scheduled within a planned gate control time. For example, if data is scheduled in the previous window or data is scheduled in the next window, this may be considered a scenario in which data enters a sending queue abnormally.

In one embodiment, the action of identifying whether data enters a sending queue abnormally is performed on the basis of the following relationship among the first time, the second time and the third time:

Firstly, T_{actual} is used to denote the first time, i.e., the time when (time-sensitive) data is actually scheduled. T_{gatestart} is used to denote the second time, i.e., the time when a gate control operation of data is planned to begin. Tᵢₙₜₑᵣᵥₐₗ is used to denote the third time, i.e., the duration of the gate control operation of data. In addition, Tₚₗₐₙ is used to denote a fourth time, which is the time when data is planned to be scheduled.

On this basis,

1) If T_{actual}−T_{gatestart}>Tᵢₙₜₑᵣᵥₐₗ, this signifies that the transmission of data is delayed until the next gate control operation, so it can be considered that the data arrives late and is not scheduled at its designated gate control operation time; this is classed as entering a sending queue abnormally.
2) If 0<=T_{actual}−T_{gatestart}<=Tᵢₙₜₑᵣᵥₐₗ, this signifies that data is transmitted in a planned gate control operation, including: a scenario in which data, despite arriving early or late, is still scheduled within a planned gate control operation time. This will not give rise to delay jitter, and may be considered a normal situation, i.e. data enters a sending queue normally. In addition, when T_{actual}−T_{gatestart}=Tᵢₙₜₑᵣᵥₐₗ, it can be ensured that data is transmitted in the present gate control operation, because there is a protective bandwidth after the end of each gate control operation, and complete transmission of data can be ensured.
3) If T_{actual}−T_{gatestart}<0, this signifies that data was transmitted early in the previous gate control operation, so it can be judged that the time-sensitive data arrived early and was not scheduled within its designated gate control operation time; this is classed as entering a sending queue abnormally.

Step S24, if data enters a sending queue abnormally, telling a data sender to adjust a sending time.

The objective of adjusting the sending time of the sender is to enable subsequent data to enter a sending queue normally. Step S24 may comprise telling the data sender to increase or decrease the sending time. In addition, in some embodiments, step S24 may comprise computing a data delay value, and feeding the delay value back to the sender, so as to instruct the sender to adjust the sending time precisely on the basis of the delay value. The delay value may be computed in the following manner:

A delay difference (i.e. delay value) may be computed on the basis of T_{actual}−Tₚₗₐₙ. In addition, to avoid delay jitter caused by accidental abnormality of a network, multiple delay values may be gathered statistically and subjected to smoothing (e.g. averaging) by using a smoothing algorithm, so as to obtain T_{final}. T_{final} is then synchronized to the sender. For the next sending operation, the sender adjusts the sending time to Tₜᵣₐₙₛₘᵢₜ−T_{final}, so as to ensure that time-sensitive data enters a sending queue normally. Tₜᵣₐₙₛₘᵢₜ is a sending time originally planned by the sender.

In this embodiment, by monitoring time-sensitive data and promptly adjusting the sending time of the sender upon detecting that data enters a sending queue abnormally, the determinism of the latency of time-sensitive data can be increased.

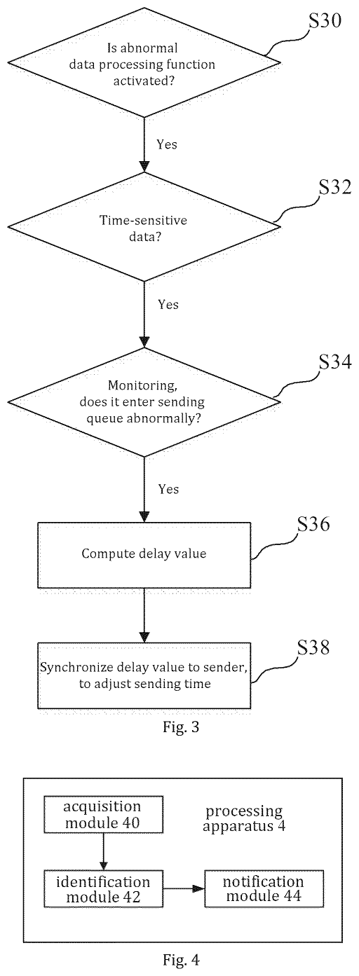

FIG. 3 shows a schematic flow chart of another embodiment of the method for processing data in a time-sensitive network. Part of the procedure of this method overlaps with the procedure of the method in FIG. 2, so the overlapping part is not described in detail again. As shown in FIG. 3, the procedure of this method comprises:

Step S30, judging whether an abnormal data processing function is activated. If so, perform step S32, otherwise return to step S30.

Step S32, judging whether data is time-sensitive data. If so, perform step S34.
Step S34, monitoring the time-sensitive data to detect whether it enters a sending queue abnormally. If so, perform step S36.
Step S36, computing a delay value.
Step S38, synchronizing the delay value to a sender, so as to adjust a sending time.

In this embodiment, an abnormal data processing function indicator bit may be set in a function register, and the value of this indicator bit may be used to indicate whether to activate the abnormal data processing function mentioned in embodiments of the disclosure. In general, in an initial stage after enabling a device, since conditions are favorable for the device in all respects, this function need not be activated, to avoid increasing the device load and link load. When the device has been operating for a period of time, the function may be activated periodically, to repair the indeterminism of latency of the network. After performing repair, the function may be deactivated. The activation or deactivation of the function may be set by means of a diagnostic instrument.

FIG. 4 shows a structural schematic drawing of an embodiment of an apparatus 4 for processing data in a time-sensitive network according to the disclosure. The data in this embodiment is time-sensitive data. The processing apparatus 6 comprises: an acquisition module 40, for acquiring a first time, a second time and a third time, wherein the first time is an actual scheduling time of data, the second time is the time when a gate control operation of data is planned to begin, and the third time is the duration of the gate control operation of data; an identification module 42, for identifying whether the data is a stream entering a sending queue abnormally on the basis of the first time, the second time and the third time; and a notification module 44, for telling a sender of the data to adjust a sending time if the data is a stream entering the sending queue abnormally.

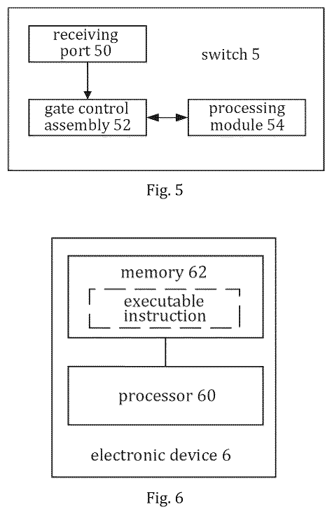

FIG. 5 shows a structural schematic drawing of an embodiment of a switch 5 according to the disclosure. The switch 5 comprises a receiving port 50, for receiving data and allocating the data to multiple queues, wherein, when the data is time-sensitive data, the data is allocated to a queue having the highest priority; a gate control assembly 52, comprising multiple gate control elements respectively corresponding to different queues; and a processing module 54, for controlling the on/off switching of each gate control element in the gate control assembly on the basis of a gate control list, so as to schedule data in each of the queues, wherein the processing module 54 is further used for: for first data in the queue having the highest priority, monitoring whether the first data enters a queue abnormally on the basis of a first time, a second time and a third time; and upon detecting that the first data enters a queue abnormally, telling a sender of the time-sensitive data to adjust a sending time, wherein the first time is an actual scheduling time of the first data, the second time is the time when a gate control operation of the first data is planned to begin, and the third time is the duration of the gate control operation of the first data.

FIG. 6 shows a schematic structural drawing of an embodiment of an electronic device 6 of the disclosure. The electronic device 6 comprises: a processor 60; and a memory 62, for storing executable instructions of the processor, wherein the processor is configured to execute the executable instructions to implement the method according to embodiments of the present disclosure.

Furthermore, embodiments of the present disclosure also provide a computer-readable storage medium having a computer program stored thereon, the computer program comprising executable instructions, wherein, when the executable instructions are executed by a processor, the method according to embodiments of the present disclosure is implemented.

The description of the storage medium and device embodiments above is similar to the description of the method embodiments above, and has beneficial effects similar to those of the method embodiments. For an understanding of technical details not disclosed in the storage medium and device embodiments of the present application, please refer to the description of the method embodiments of the present application.

The processor may be at least one of an application-specific integrated circuit (ASIC), a digital signal processor (DSP), a digital signal processing device (DSPD), a programmable logic device (PLD), a field programmable gate array (FPGA), a central processing unit (CPU), a controller, a microcontroller and a microprocessor, etc. It will be understood that other electronic devices could also realize the abovementioned processor functions, and embodiments of the present application do not impose specific limitations.

The computer storage medium/memory may be read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, optical discs or compact disc read-only memory (CD-ROM), etc.; or may be various terminals comprising one of the above memories or any combination thereof, such as mobile phones, computers, tablet devices, personal digital assistants, etc.

It should be pointed out that the description above is merely an example and does not restrict the present invention. In other embodiments of the present invention, the method may have more, fewer or different steps, and relationships among steps such as sequential, inclusion and functional relationships may be different to those described and shown. For example, generally, multiple steps may be combined to form a single step, and a single step may be split into multiple steps. To a person skilled in the art, changes to the sequence of steps are also within the scope of protection of the present invention, as long as no inventive effort is expended.

The technical solution ofthe present invention essentially, i.e., the part thereof that makes a contribution to the prior art, or all or part of the technical solution, may be embodied in the form of a software product, the computer software product being stored in a storage medium, and comprising instructions for causing a computer device (which may be a personal computer, a server or a network device, etc.) or a processor or microcontroller to execute all or some of the steps of the method described in the various embodiments of the present disclosure.

Those skilled in the art will understand that all or some of the steps in the method embodiments described above may be realized by means hardware associated with program instructions. The abovementioned program may be stored in a computer-readable storage medium. When the program is executed, the execution comprises steps of the method embodiments described above.

Although the subject matter has been disclosed above with preferred embodiments, the present invention is not limited to this. Any change or modification made by those skilled in the art without departing from the spirit and scope of the present invention should be included in the scope of protection thereof. Thus, the scope of protection of the present invention shall be the scope defined by the claims.

1. A method for processing data in a time-sensitive network, the data being time-sensitive data, wherein the method comprises:
acquiring a first time corresponding to a time when the data is scheduled, a second time corresponding to a time when a gate control operation of the data is planned to begin, and a third time corresponding to a duration of a gate control operation of the data;
identifying whether the data enters a sending queue abnormally on the basis of the first time, the second time, and the third time; and
informing a sender of the data to adjust a sending time in response to the data entering the sending queue abnormally.

2. The method as set forth in claim 1, wherein identifying whether the data enters a sending queue abnormally comprises determining if the difference between the first time and the second time is greater than the third time and/or determining if the difference between the first time and the second time is less than 0.

3. The method as set forth in claim 1, wherein informing the sender of the data to adjust a sending time comprises informing the sender of the data to adjust the sending time on the basis of a delay value of the data, wherein the delay value is computed on the basis of the first time and a fourth time, the fourth time being a time when the data is planned to be scheduled.

4. The method as set forth in claim 3, further comprising computing the delay value of data multiple times and using a smoothing algorithm to subject multiple computed delay values to smoothing, so as to obtain a final delay value, and the sender is informed to adjust the sending time on the basis of the final delay value.

5. The method as set forth in claim 1, further comprising:
identifying whether the data is time-sensitive data; and
putting the data into a sending queue having the highest priority in response to identifying that the data is time-sensitive data.

6. The method as set forth in claim 1, further comprising:
identifying whether an abnormal flow processing function is activated; and
identifying whether the data enters a sending queue abnormally in response to the abnormal flow processing function being activated.

7. The method as claimed in claim 6, wherein a value of a function register is used to indicate activation or deactivation of the abnormal flow processing function.

8. A method for processing data in a time-sensitive network, the method comprising:
receiving at least one item of data;
allocating the at least one item of data to multiple sending queues on the basis of a characteristic of the at least one item of data, wherein time-sensitive data is allocated to a sending queue having the highest priority;
scheduling data in the multiple sending queues on the basis of a preset gate control list;
when scheduling the time-sensitive data, monitoring whether the time-sensitive data enters the sending queue having the highest priority normally; and
upon detecting that the time-sensitive data enters the sending queue having the highest priority abnormally, performing an adjustment operation, so that the time-sensitive data is able to enter the sending queue having the highest priority normally.

9. The method as set forth in claim 8, wherein, when the time-sensitive data enters a sending queue early or late and is not scheduled within a specified gate control time, the time-sensitive data is considered to enter a sending queue abnormally.

10. An apparatus for processing data in a time-sensitive network, the data being time-sensitive data, wherein the processing apparatus comprises:
an acquisition module, for acquiring a first time, a second time and a third time, wherein the first time is a time when the data is actually scheduled, the second time is a time when a gate control operation of the data is planned to begin, and the third time is a duration of a gate control operation of the data;
an identification module, for identifying whether the data enters a sending queue abnormally on the basis of the first time, the second time and the third time acquired by the acquisition module; and
a notification module, for informing a sender of the data to adjust a sending time when the identification module identifies that the data enters a sending queue abnormally.
